(19) United States
(12) Patent Application Publication
(10) Pub. No.: US 2018/0056407 A1
(43) Pub. Date: Mar. 1, 2018

(54) MILLING CUTTER COMPRISING A CUTTING EDGE DISPOSED ON THE PERIPHERY

(71) Applicant: ALBERT KNEBEL HOLDING GMBH, Balingen (DE)

(72) Inventor: Alexander KNEBEL, Balingen (DE)

(73) Assignee: ALBERT KNEBEL HOLDING GMBH, Balingen (DE)

(21) Appl. No.: 15/556,693

(22) PCT Filed: Mar. 9, 2016
(86) PCT No.: PCT/EP2016/055017

§ 371 Date: Sep. 8, 2017

(30) Foreign Application Priority Data
Mar. 9, 2015 (DE) 20 2015 101 167.9

(51) Int. Cl. B23C 5/00; B23C 5/10

(52) U.S. Cl. CPC B23C 5/006; B23C 2210/40; B23C 2230/04; B23C 5/10

(57) ABSTRACT

The invention relates to a milling cutter (1) comprising a substantially cylindrical tool body (2) and at least one peripheral cutting edge (3) protruding exclusively radially over the tool body (2), to which cutting edge a chip removal space (4) is assigned, wherein at least one section of the chip removal space (4), which is trough-shaped in particular, is provided behind the cutting edge (3), at least in the peripheral direction.

The invention relates to a milling cutter comprising a substantially cylindrical tool body and at least one peripheral cutting edge protruding exclusively radially over the tool body, to which cutting edge a chip removal space is assigned.

In the case of conventional milling cutters comprising a radially oriented cutting edge, a chip removal space in which chips are collected is provided in front of the cutting edge. The chip removal space is provided in order to prevent chips from impacting the subsequent cutting edges. The chip removal space is emptied after the removal from the workpiece.

During the machining of wood and wood materials as well as plastics, “twofold machining” can take place. In this case, a chip that has already been formed by a cutting edge impacts subsequent teeth—even though there is a chip removal space disposed in front of the cutting edge—and is cut up again. This effect accelerates the blunting of the tools and reduces the amount of chip material collected.

The problem addressed by the present invention is that of refining a milling cutter in such a way that twofold machining is avoided to the greatest possible extent.

This problem is solved according to the invention by a milling cutter comprising a substantially cylindrical tool body and at least one peripheral cutting edge protruding exclusively radially over the tool body, to which cutting edge a chip removal space is assigned, wherein a section of the chip removal space, which is trough-shaped in particular, is provided behind the cutting edge, at least in the peripheral direction. The section of the chip removal space that is disposed behind the cutting edge is situated, in particular, at a distance from the next cutting edge. Therefore, this is not a chip removal space that is assigned to a subsequent cutting edge. Due to the fact that a section of the chip removal space is disposed behind the cutting edge, chips having less energy can also be captured via suction before impacting the next cutting edge. Chips having less kinetic energy are collected behind the cutting edge, in a targeted manner, in the chip-removal-space section disposed there. The chips produced during the machining break up and lose a portion of the energy supplied via the rotation.

The chip removal space can be open on the peripheral side, in particular exclusively and not on the end face. In particular, the chip removal space can be designed as a radial recess. As a result, a reliable removal of the chips is ensured.

The chip removal space can be designed in such a way that chip material is forced to come loose from the tool body. In this way, the chips can be captured particularly easily by suctioning.

Particular advantages result when the chip removal space is disposed in such a way that one section is situated laterally with respect to the cutting edge. As a result, chips can be guided laterally past the cutting edge and conveyed into the chip-removal-space section behind the cutting edge. As a result, a chip is actively conveyed behind the cutting edge. Flows and turbulent air provide assistance in this case.

In addition, it can be provided that the chip removal space is disposed such that one section is situated in front of the cutting edge. In this way, there is a larger chip removal space, overall, for capturing chips. Chips can be conveyed, in particular, from the section in front of the cutting edge, along the section next to the cutting edge, and into the section behind the cutting edge. Twofold machining can therefore be prevented in an effective way.

Further advantages result when the chip-removal-space section disposed behind the cutting edge form an acute angle with a cutting edge back. A chip is therefore carried away, at a slant, behind the cutting edge.

In addition, it can be provided that the chip removal space surrounds the cutting edge by more than 60%. The chip removal space can therefore be designed to be substantially annular, wherein the ring is slotted. The largest section of the chip removal space can still lie in front of the cutting edge in this case.

According to one embodiment of the invention, a chip channel can be provided, which interconnects two chip removal spaces assigned to different cutting edges. In this case, the chip channel can form one section of the chip removal space, which is disposed in front of and/or behind the cutting edge. In particular, the chip channel can extend laterally past a second cutting edge following a first cutting edge. As a result, the case is prevented in which chips generated by the first cutting edge are captured by the second, subsequent cutting edge. Said chips are conveyed past this cutting edge by means of the chip channel.

The chip channel can therefore extend in front of and/or behind a cutting edge.

It is particularly advantageous when the chip channel is designed in the shape of a helix. The chips can therefore be guided—in the case of a rotating tool—along the helical shape of the chip channel.

Twofold machining can additionally be avoided in that the chip-removal-space section disposed behind the cutting edge is situated in such a way that at least one region is located under a plane, the position of which is defined by the underside of the cutting edge.

Alternatively or additionally, it can be provided that the chip-removal-space section disposed behind the cutting edge is situated in such a way that one region is located above a plane, the position of which is defined by the underside of the cutting edge.

The milling cutter can be designed as a notching or profiling cutter. A cutting edge support can be provided, on which the cutting edge is disposed. In this case, the cutting edge can be an integral component of the cutting edge support or can consist of another material and can be fastened on the cutting edge support. The cutting edges can be provided with a cutting material or can be formed from a material that has a greater hardness than the tool body. The cutting material and, therefore, the cutting edge, can consist of hard metal, polycrystalline diamond (PCD), hardened steel, stellite, or another suitable hard material.

The milling cutter can have a receiving opening, in particular a receiving hole, for accommodating a shaft or a tool holder. In particular, the milling cutter having the receiving opening can be inserted onto a drive shaft of a machine tool or can be fastened on the machine tool via the receiving opening. Alternatively, the milling cutter can be designed as a shank-type tool which can be fastened, via one end, in a chuck of a machine tool. With the aid of a shank-type tool, other (smaller) geometries can be attained or milled than is the case with the aid of a milling cutter having a receiving opening.

Preferably, a cutting material such as PCD is utilized, since no abrasive machining on the front face of the cutting edge (rake face) needs to take place in this case.

The cutting edge can be connected to the tool body, in particular to the cutting edge support, by means of soldering, bonding, welding, or by means of another suitable method. The cutting edge can be additionally provided with a hard-material coating. This coating can be designed as a monolayer, a multilayer, a gradient layer, a composite structure, or in another suitable manner.

In this case, a monolayer is understood to be a coating which consists of a sheet layer. Correspondingly, a multilayer is understood to be a coating made of multiple layers of one and the same sheet material or a coating made of multiple layers of different coating materials applied in alternation. A gradient layer is understood to be the coating with layer material consisting of at least two different components, wherein the mixing ratio or the portions of the individual components within the layer change continuously or steplessly. A composite structure is understood to be a coating with a supporting structure, which is generally lattice-like, at the atomic or molecular level and dispersing one or more further components into this structure. The cutting edges can have any type of geometry.

Further features and advantages of the present invention result from the detailed description of embodiments of the present invention that follows, with reference to the figures in the drawing which shows the details that are essential to the present invention. Further features and advantages of the present invention also result from the claims. The features described therein are not intended to be interpreted literally, and are presented in such a manner that the special features of the present invention may be presented clearly. The various features can be implemented individually, or these can be combined in any possible manner in different variants of the invention.

Exemplary embodiments of the invention are depicted in the schematic drawing and are described in greater detail in the description that follows.

In the drawing:

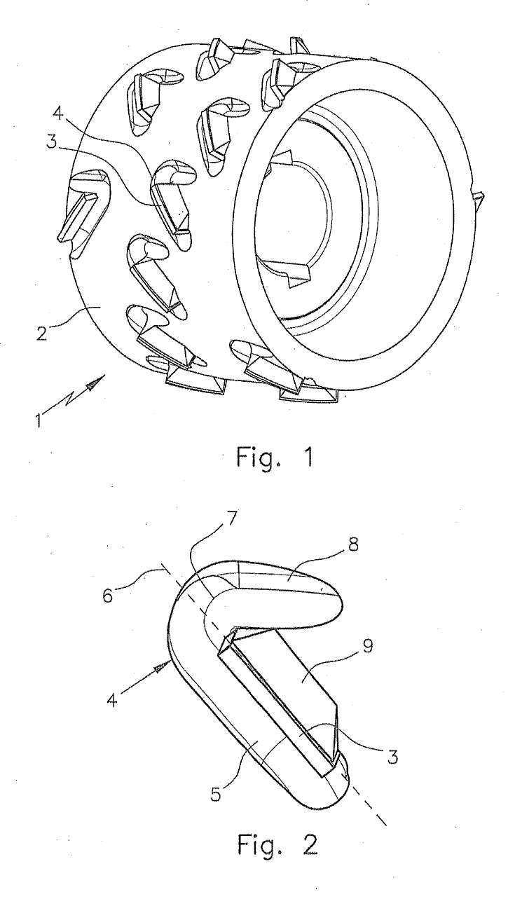

FIG. 1 shows a first embodiment of a milling cutter;

FIG. 2 shows an enlarged cutout of the representation from FIG. 1;

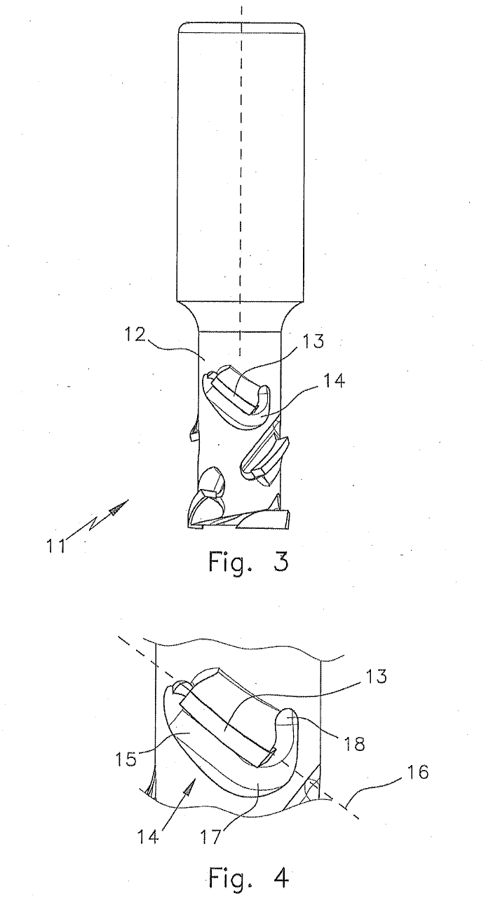

FIG. 3 shows one alternative embodiment of a milling cutter;

FIG. 4 shows an enlarged cutout from FIG. 3;

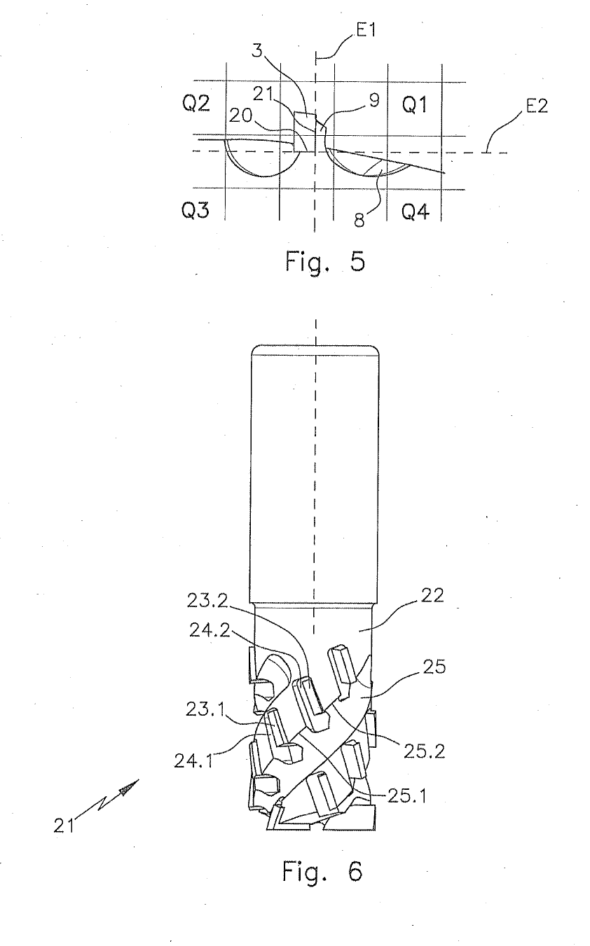

FIG. 5 shows a partial sectional representation of a milling cutter in the region of a cutting edge;

FIG. 6 shows a third embodiment of a milling cutter comprising a chip channel; and

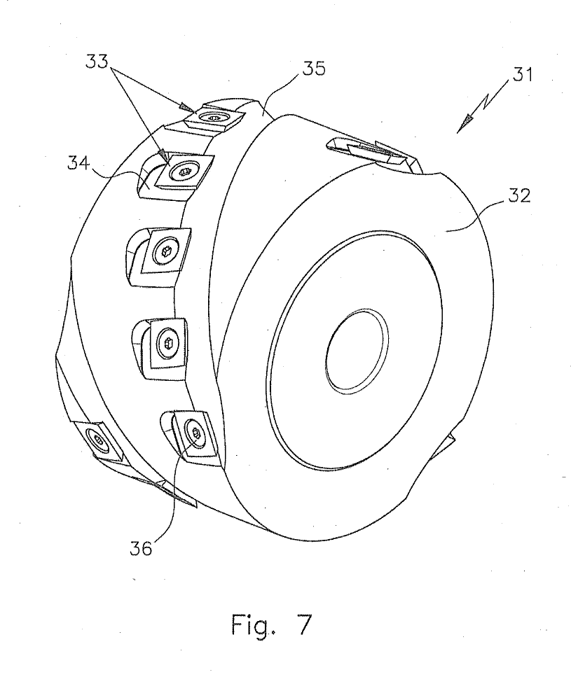

FIG. 7 shows a fourth embodiment of a milling cutter.

FIG. 1 shows a milling cutter 1 comprising a substantially cylindrical tool body 2 and a receiving opening for fastening on a machine tool. Cutting edges 3 are disposed on the machine body 2, which cutting edges protrude radially over the tool body 2. Assigned to the cutting edge 3 is a chip removal space 4 which is described in greater detail with reference to FIG. 2.

It is apparent in FIG. 2 that the chip removal space 4 includes a chip removal space 5 which is disposed in front of the cutting edge 3. In particular, the chip removal space 5 is disposed in front of a cutting edge back 6 in a plane E1 (see FIG. 5). A further section 7 of the chip removal space 4 is situated laterally with respect to the cutting edge 3. Abutting said further section is a section 8 which is disposed behind the cutting edge 3. The chip removal space 4 therefore partially surrounds the cutting edge 3. A chip that is generated by the cutting edge 3 travels via the chip-removal-space section 5 and the chip-removal-space section 7 to the chip-removal-space section 8 and, therefore, travels behind the cutting edge 3. As a result, twofold machining can be avoided.

The chip-removal-space section 8 is disposed at an acute angle with respect to the cutting edge back 6. The chip removal space 4 is open exclusively on the peripheral side, i.e., radially. In particular, said chip removal space is not disposed in the region of an end face of the milling cutter 1, nor is it open toward the end face. The chip removal space 4 is designed in the form of a trough.

It is also clear from FIG. 2 that the cutting edge 3 is disposed on a cutting edge support 9.

FIG. 3 shows an alternative embodiment of a milling cutter 11 which comprises a substantially cylindrical tool body 12. In particular, the milling cutter 11 is designed as a shank-type tool. A cutting edge 13, to which a chip removal space 14 is assigned, protrudes radially from the cylindrical tool body 12. This is described in greater detail with reference to the representation from FIG. 4.

It is apparent in FIG. 4 that the chip removal space 14 includes a chip-removal-space section 15 which is disposed in front of the cutting edge 13. In particular, the chip-removal-space section 15 is disposed in front of a cutting edge back 16. Adjoining the chip-removal-space section 15 is the section 17 of the chip removal space, which is situated laterally with respect to the cutting edge 13. This is adjoined by the section 18 which extends up to behind the cutting edge 13 and also behind the cutting edge back 16. The chip-removal-space section 18 is disposed at an acute angle with respect to the cutting edge back 16. The chip removal space 14 is designed in the shape of a trough in this case as well. A chip formed by the cutting edge 13 is carried away via the chip-removal-space sections 15, 17, 18 and is guided behind the cutting edge 13.

FIG. 5 shows a sectional representation through a milling cutter. FIG. 5 is described using the reference numbers according to FIG. 1. In this case, it is clear that the cutting edge 3 is disposed on the cutting edge support 9. The underside 20 of the cutting edge 3 defines a plane E2. The back side 21 of the cutting edge 3 defines a plane E1, and so a total of four quadrants Q1 to Q4 results. The chip-removal-space section 8 is disposed, via its preponderant region, below the plane E2. A small region is also disposed above the plane E2, however. The chip-removal-space section 8 is therefore disposed primarily in the quadrant Q4. Only a small region is disposed in the quadrant Q1. It is also conceivable that the chip-removal-space section 8, which is disposed behind the cutting edge 3, is disposed only in the quadrant Q1, i.e., above the plane E2, or only in the quadrant Q4, i.e., under the plane E2.

FIG. 6 shows one further embodiment of a milling cutter 21. The milling cutter 21 comprises a substantially cylindrical body 22, on which a first cutting edge 23.1 and a second cutting edge 23.2 are situated. The cutting edges 23.1 and 23.2 are designed as peripheral cutting edges and protrude radially over the tool body 22. Assigned to each of the cutting edges 23.1, 23.2 is a chip removal space 24.1, 24.2. The chip removal spaces 24.1, 24.2 open into a chip channel 25 which is designed in the shape of a helix and connects the chip removal spaces 24.1, 24.2. The chip channel 25, by way of its section 25.1, is the chip-removal-space section that is disposed behind the cutting edge 23.1, and by way of its section 25.2, is the chip-removal-space section that is disposed behind the cutting edge 23.2. By means of the chip channel 25, chips—for example chips that are generated by the cutting edge 23.1—are effectively kept away from a subsequent cutting edge, e.g., the cutting edge 23.2, since they are guided laterally past this cutting edge.

The milling cutter 31 represented in FIG. 7 is designed similarly to the milling cutter 21. It comprises a cylindrical body 32, on which radially protruding peripheral cutting edges 33 are disposed, which cutting edges are designed to be replaceable in this case. Said cutting edges are fastened on the body 32 by means of screws 36. A chip removal space 34, which opens into a helical chip channel 35, is disposed around each of the cutting edges 33. The channel 35 collects the chips from multiple chip removal spaces 34 and conveys them past the cutting edges 33 and out of the tool 31.

1-14. (canceled)

15. A milling cutter (1, 11) comprising a substantially cylindrical tool body (2, 12) and at least one peripheral cutting edge (3, 13) protruding exclusively radially over the tool body (2, 12), to which cutting edge a chip removal space (4, 14) is assigned, wherein at least one section (8, 18) of the chip removal space (4, 14), which is trough-shaped, is provided behind the cutting edge (3, 13), at least in the peripheral direction, wherein the chip removal space (4, 14) is open exclusively on a peripheral side and not on an end face.

16. The milling cutter according to claim 15, wherein the chip removal space (4, 14) is designed in such a way that chip material is forced to come loose from the tool body.

17. The milling cutter according to claim 15, wherein the chip removal space (4, 14) is disposed in such a way that one section (7, 17) is situated laterally with respect to the cutting edge (3, 13).

18. The milling cutter according to claim 15, wherein the chip removal space (4, 14) is disposed in such a way that one section (5, 15) is situated in front of the cutting edge (3, 13).

19. The milling cutter according to claim 15, wherein a chip-removal-space section (8, 18) disposed behind the cutting edge (3, 13) forms an acute angle with a cutting edge back (6, 16).

20. The milling cutter according to claim 15, wherein the chip removal space (4, 14) surrounds the cutting edge (3, 13) by more than 60%.

21. The milling cutter according to claim 15, wherein a chip channel is provided, which connects two chip removal spaces assigned to different cutting edges, wherein the chip channel extends in front of and/or behind a cutting edge.

22. The milling cutter according to claim 15, wherein the chip channel is designed in the shape of a helix.

23. The milling cutter according to claim 15, wherein the chip-removal-space section (8, 18) disposed behind the cutting edge (3, 13) is situated in such a way that at least one region is located under a plane (E2), the position of which is defined by the underside (20) of the cutting edge (3, 13).

24. The milling cutter according to claim 15, wherein a chip-removal-space section (8, 18) disposed behind the cutting edge (3, 13) is situated in such a way that at least one region is located above a plane (E2), the position of which is defined by the underside (20) of the cutting edge (3, 13).

25. The milling cutter according to claim 15, wherein the milling cutter is designed as a notching or profiling cutter.

26. The milling cutter according to claim 15, wherein the milling cutter has a receiving opening for accommodating a shaft or a tool holder.

27. The milling cutter according to claim 15, wherein the milling, cutter is designed as a shank-type tool.
